(19) United States
(12) Patent Application Publication
(10) Pub. No.: US 2009/0124720 A1
(43) Pub. Date: May 14, 2009

(54) PHOTOCURABLE INK COMPOSITION FOR INK-JET PRINTING

(75) Inventors: Tatsuro TSUCHIYA, Osaka-shi (JP); Shinya MIZUTANI, Osaka-shi (JP); Okinori NAKASHIMA, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SAKATA INX CORP., Osaka (JP)

(21) Appl. No.: 11/938,512

(22) Filed: Nov. 12, 2007

(51) Int. Cl. C08F 2/46

(52) U.S. Cl. 522/182

(57) ABSTRACT

The present invention aims to provide a photocurable ink composition for ink-jet printing having excellent photocurability, favorable adhesiveness to a substrate, and excellent elongation property and flexibility.

The present invention relates to a photocurable ink composition for ink-jet printing containing:
a ketone resin having a hydroxyl group;
as a photopolymerizable compound,
(a) aromatic ring-containing acrylate, which is represented by the following formula (I), and isobornyl acrylate and/or (b) trimethylcyclohexane acrylate,

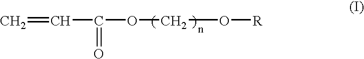

(in the formula, “R” represents an aromatic ring in which a hydrogen atom may be substituted by an alkyl group, and “n” represents an integer from 0 to 5);
and a photopolymerization initiator,
a blending ratio of said aromatic ring-containing acrylate to said isobornyl acrylate being 70/30 to 30/70 by mass, and
a content of said ketone resin having a hydroxyl group being 8 to 20% by mass.

### TECHNICAL FIELD

The present invention relates to a photocurable ink composition for ink-jet printing. Further, the present invention relates to a photocurable ink composition for ink-jet printing having favorable adhesiveness to a substrate, and excellent elongation property and flexibility.

### BACKGROUND ART

A photocurable ink has excellent performance; that is, drying is fast, the photocurable ink does not contain a volatile solvent, components harmful to the environment do not volatilize, the photocurable ink can be printed on various substrates, and the like. For this reason, the photocurable ink is used in broad fields, such as various kinds of coating and ink-jet printing, in addition to offset printing, gravure printing, screen printing, and letterpress printing.

In particular, since the ink-jet printing enables easy and low-cost creation of images regardless of materials and shapes of substrates, the ink-jet printing is applicable to various fields ranging from general printing of logos, figures, photo images, etc. to special printing of markings, color filters, etc. For this reason, there is a growing expectation that in the ink-jet printing, more favorable printed substances can be obtained also because of the performance of the photocurable ink.

However, a cured film of the photocurable ink using conventional polyfunctional monomers and monofunctional monomers typically has high film hardness. For this reason, the cured film tended to be fragile and have low adhesiveness to a substrate. Since the utilization of a photocurable ink in recent years is such that after preceding printing of the photocurable ink on a sheet-like substrate, the ink is cured and subsequently a molding process is carried out, a cured film of the ink having suitability of elongation property has been required. In this case, flexibility of the film and adhesiveness to the substrate are required so that the film may not be peeled especially even when the substrate is drawn. However, in conventional photocurable inks, there has been a problem that suitability of elongation property thereof is low.

Thus, in order to solve these problems, there is proposed an active energy ray-curing type ink for ink-jet (for example, see Patent Document No. 1) containing a polyfunctional monomer, which has a plurality of photocurable ethylenically double bonds in which a formula weight between the two ethylenically double bonds is 250 or more, phenoxyethyl acrylate, and isobornyl acrylate.

However, in the case where a printed substance is manufactured using such ink-jet ink, although adhesiveness to a substrate and elongation property are improved to a certain extent, the improvement has not reached a sufficient level.

### Patent Document No. 1: Japanese Kokai Publication 2007-131754;

### SUMMARY OF THE INVENTION

It is an object of the present invention to provide a photocurable ink composition for ink-jet printing having excellent photocurability, favorable adhesiveness to a substrate, and excellent elongation property and flexibility.

The present inventors made various investigations, and consequently they found that all the problems can be solved by employing a specific amount of a ketone resin having a hydroxyl group, and a specific monofunctional monomer as a photopolymerizable compound. These findings have now led to completion of the present invention.

That is, the present invention relates to (1) a photocurable ink composition for ink-jet printing containing:

a ketone resin having a hydroxyl group;

as a photopolymerizable compound,

(a) aromatic ring-containing acrylate, which is represented by the following formula (I), and isobornyl acrylate and/or (b) trimethylcyclohexane acrylate,

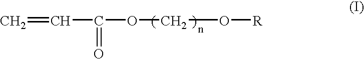

(in the formula, “R” represents an aromatic ring in which a hydrogen atom may be substituted by an alkyl group, and “n” represents an integer from 0 to 5);

and a photopolymerization initiator,

a blending ratio of the aromatic ring-containing acrylate to the isobornyl acrylate being 70/30 to 30/70 by mass, and

a content of the ketone resin having a hydroxyl group being 8 to 20% by mass.

In addition, the present invention relates to (2) the photocurable ink composition for ink-jet printing according to (1), wherein the aromatic ring-containing acrylate is phenoxyethyl acrylate.

In addition, the present invention relates to (3) the photocurable ink composition for ink-jet printing according to (1) or (2), wherein 1 to 10% by mass of acrylated amine compound having two photopolymerizable functional groups and two amino groups in the molecule is further contained as the photopolymerizable compound in the photocurable ink composition for ink-jet printing.

In addition, the present invention relates to (4) the photocurable ink composition for ink-jet printing according to any one of (1) to (3), wherein 1 to 10% by mass of N-vinyl caprolactam is further contained as the photopolymerizable compound in the photocurable ink composition for ink-jet printing.

In addition, the present invention relates to (5) the photocurable ink composition for ink-jet printing according to any one of (1) to (4), wherein a total content of polyfunctional monomers contained in the photocurable ink composition for ink-jet printing is 1 to 10% by mass.

In addition, the present invention relates to (6) the photocurable ink composition for ink-jet printing according to any one of (1) to (5), wherein a viscosity at 25° C. is 5 to 50 mPa·s.

In addition, the present invention relates to (7) the photocurable ink composition for ink-jet printing according to any one of (1) to (6), further containing a pigment.

Hereinafter, the photocurable ink composition for ink-jet printing of the present invention (hereinafter, also referred to as an “ink composition”), and printed substances to be obtained by using it will be described in detail.

### DETAILED DESCRIPTION OF THE INVENTION

### <Ink Ccomposition>

First, a photopolymerizable compound contained in the ink composition of the present invention will be described specifically.

As the photopolymerizable compound, (a) aromatic ring-containing acrylate, which is represented by the following formula (I), and isobornyl acrylate and/or (b) trimethylcyclohexane acrylate is/are used as a principal component.

In the formula (I), “R” represents an aromatic ring in which a hydrogen atom may be substituted by an alkyl group, and “n” represents an integer from 0 to 5.

Examples of the alkyl group include a methyl group, an ethyl group, a propyl group, an isopropyl group, a butyl group, an isobutyl group, an s-butyl group, a t-butyl group, a pentyl group, a hexyl group, an octyl group, a decyl group, and the like.

Specific examples of the aromatic ring-containing acrylate include phenoxy acrylate, phenoxymethyl acrylate, phenoxyethyl acrylate, and the like.

In the ink composition, a blending ratio of the aromatic ring-containing acrylate to the isobornyl acrylate is 70/30 to 30/70 (aromatic ring-containing acrylate/isobornyl acrylate) by mass.

In the case where the blending ratio of the aromatic ring-containing acrylate becomes more than 70, adhesiveness to a substrate tends to decrease; whereas in the case where the blending ratio of the isobornyl acrylate becomes more than 70, elongation property and crease resistance on the printed substance tend to decrease. Therefore, both cases are not preferable.

In the ink composition of the present invention, the total blending amount of the aromatic ring-containing acrylate, the isobornyl acrylate, and the trimethylcyclohexane acrylate is preferably 70% by mass or more, and more preferably 80% by mass or more, in all the photopolymerizable compounds to be used.

Further, in order to improve curability and crease resistance, it is preferable to add N-vinyl caprolactam, and an acrylated amine compound (acrylated amine synergist) having two photopolymerizable functional groups and two amino groups in the molecule, as the photopolymerizable compound.

A blending amount of the N-vinyl caprolactam is preferably 1 to 10% by mass, and more preferably 1 to 9%, in the ink composition.

A blending amount of the acrylated amine compound (acrylated amine synergist) having two photopolymerizable functional groups and two amino groups in the molecule is preferably 1 to 10% by mass, and more preferably 1 to 9%, in the ink composition.

Here, examples of the acrylated amine compound (acrylated amine synergist) having two photopolymerizable functional groups and two amino groups in the molecule include an acrylated amine compound that is obtained by reacting bifunctional (meth)acrylate with an amine compound and that has an amine value of 130 to 142 mgKOH/g.

Examples of the bifunctional (meth)acrylate include: alkylene glycol di(meth)acrylates such as 1,4-butanediol di(meth)acrylate, 1,6-hexanediol di(meth)acrylate, 1,9-nonanediol di(meth)acrylate, propylene glycol di(meth)acrylate, 1,3-butylene glycol di(meth)acrylate, and neopentyl glycol di(meth)acrylate; bisphenol alkylene oxide adduct di(meth)acrylates such as bisphenol A ethylene oxide adduct di(meth)acrylate, bisphenol F ethylene oxide adduct di(meth)acrylate, bisphenol S ethylene oxide adduct di(meth)acrylate, thiobisphenol ethylene oxide adduct di(meth)acrylate, and brominated bisphenol A ethylene oxide adduct di(meth)acrylate; polyalkylene glycol di(meth)acrylate such as polyethylene glycol di(meth)acrylate and polypropylene glycol di(meth)acrylate; hydroxypivalic acid neopentyl glycol ester di(meth)acrylate; and the like. Among others, 1,6-hexanediol di(meth)acrylate is preferable.

Examples of the amine compound include: monofunctional amine compounds such as benzylamine, phenethylamine, ethylamine, n-propylamine, isopropylamine, n-butylamine, isobutylamine, n-pentylamine, isopentylamine, n-hexylamine, cyclohexylamine, n-heptylamine, n-octylamine, 2-ethylhexylamine, n-nonylamine, n-decylamine, n-dodecylamine, n-tetradecylamine, n-hexadecylamine, and n-octadecylamine; and polyfunctional amine compounds such as diethylenetriamine, triethylenetetramine, tetraethylenepentamine, 1,6-hexamethylenediamine, 1,8-octamethylenediamine, 1,12-dodecamethylenediamine, o-phenylenediamine, p-phenylenediamine, m-phenylenediamine, o-xylylenediamine, p-xylylenediamine, m-xylylenediamine, menthanediamine, isophoronediamine, 1,3-diaminocyclohexane, and spiroacetal-based diamine. In addition, examples of the amine compound also include polyfunctional amine compounds of high molecular weight type such as polyethyleneimine, polyvinylamine, and polyallylamine.

As the acrylated amine compound, a compound obtained by reacting 1,6-hexanediol di(meth)acrylate with an amine compound is preferably used. Specific examples thereof include CN371 (manufactured by SARTOMER Company, Inc.), EB-7100 (EBECRYL 7100, manufactured by Cytec), and the like.

Moreover, in the present specification, the amine value means an amine value per 1 g of solid content, that is, a value converted into an equivalent amount of potassium hydroxide after measured by potentiometer titration (for example, COMTITE (AUTO TITRATOR COM-900, BURET B-900, and TITSTATIONK-900), manufactured by Hiranuma Sangyo Corporation) using 0.1 N of aqueous hydrochloric acid.

Further, as the photopolymerizable compound, it is possible to use other photopolymerizable compounds in combination to the extent that they do not lower the performance. As such other photopolymerizable compounds, it is possible to use monomers, prepolymers, oligomers, and the like without any particular limitations as long as they are ethylenically double bond-containing compounds.

Specific examples thereof include ethylene glycol di(meth)acrylate, diethylene glycol di(meth)acrylate, polyethylene glycol di(methacrylate, 1,6-hexanediol di(meth)acrylate, ethoxylated 1,6-hexanediol diacrylate, neopentyl glycol di(meth)acrylate, ethoxylated neopentyl glycol di(meth)acrylate, propoxylated neopentyl glycol di(meth)acrylate, tripropylene glycol di(meth)acrylate, polypropylene glycol diacrylate, 1,4-butanediol di(meth)acrylate, 1,9-nonanediol diacrylate, tetraethylene glycol diacrylate, 2-n-butyl-2-ethyl-1,3-propanediol diacrylate, dimethyloltricyclodecane diacrylate, hydroxypivalic acid neopentyl glycol diacrylate, 1,3-butylene glycol di(meth)acrylate, ethoxylated bisphenol A di(meth)acrylate, propoxylated bisphenol A di(meth)acrylate, cyclohexane dimethanol di(meth)acrylate, dimethyloldicyclopentane diacrylate, trimethylolpropane triacrylate, ethoxylated trimethylolpropane triacrylate, propoxylated trimethylolpropane triacrylate, pentaerythritol triacrylate, tetramethylolpropane triacrylate, tetramethylolmethane triacrylate, pentaerythritol tetraacrylate, ethylene oxide modified pentaerythritol tetraacrylate, caprolactone modified trimethylolpropane triacrylate, ethoxylated isocyanuric acid triacrylate, tris(2-hydroxyethylisocyanurate) triacrylate, propoxylateglyceryl triacrylate, tetramethylolmethane tetraacrylate, pentaerythritol tetraacrylate, ditrimethylolpropane tetraacrylate, ethoxylated pentaerythritol tetraacrylate, dipentaerythritol hexaacrylate, neopentyl glycol oligoacrylate, 1,4-butanediol oligoacrylate, 1,6-hexanediol oligoacrylate, trimethylolpropane oligoacrylate, pentaerythritol oligoacrylate, urethane acrylate, epoxy acrylate, polyester acrylate, acryloyl morpholine, 2-hydroxyethyl acrylate, 2-hydroxypropyl acrylate, 4-hydroxybutyl acrylate, isobutyl acrylate, t-butyl acrylate, isooctyl acrylate, cyclohexyl acrylate, 2-methoxyethyl acrylate, methoxytriethylene glycol acrylate, 2-ethoxyethyl acrylate, tetrahydrofurfuryl acrylate, 3-methoxybutyl acrylate, benzyl acrylate, ethoxyethoxyethyl acrylate, butoxyethyl acrylate, ethoxy diethylene glycol acrylate, methoxy dipropylene glycol acrylate, methylphenoxyethyl acrylate, dipropylene glycol acrylate, those which these compounds are modified with ethylene oxide (EO) or propylene oxide (PO), and the like. These other photopolymerizable compounds may be used singly or as a mixture of two or more of them if necessary.

All the contents (total blending amount) of the polyfunctional monomers contained in the ink composition of the present invention are preferably 1 to 10% by mass. In the case where the total usage of the polyfunctional monomers exceeds 10% by mass, adhesiveness and elongation property may decrease, and this is not preferable. In the case where the total usage of the polyfunctional monomers is less than 1% by mass, curability tends to decrease, and this is not preferable.

Next, a ketone resin having a hydroxyl group contained in the ink composition of the present invention will be described specifically. The use of the ketone resin having a hydroxyl group in combination with the specific monomers enables excellent photocurability, adhesiveness to a substrate, and elongation property.

The ketone resin having a hydroxyl group is not particularly limited as long as it dissolves in the above-mentioned aromatic ring-containing acrylate, isobornyl acrylate, and trimethylcyclohexane acrylate, and conventionally known resins may be used.

Examples thereof include a ketone resin having a hydroxyl group obtained by reacting a ketone group-containing compound with an aldehyde compound and then hydrogenating the resulting ketone resin.

Examples of the ketone group-containing compound include an aromatic ketone compound, an alicyclic ketone compound, an aliphatic ketone compound, a heterocyclic ketone compound, and the like.

Examples of the aromatic ketone compound include acetophenone, propiophenone, benzophenone, deoxybenzoin, 1-naphthalenone, and the like. Examples of the alicyclic ketone compound include cyclobutanone, cyclopentanone, cyclohexanone, cyclooctanone, cyclononanone, and cyclodecanone, cycloundecanone, cyclododecanone, cyclotetradecanone, cyclooctadecanone, cycloeicosanone, 2-methylcyclohexanone, 2-ethylcyclohexanone, 2,6-dimethylcyclahexanone, trimethylcyclohexanone, 4-chlorocyclohexanone, 4-methoxycyclohexanone, cyclohexanedione, cyclopentenone, cyclohexanone, cyclooctenone, cyclodecenone, and the like. Examples of the aliphatic ketone compound include acetone, methyl ethyl ketone, diethyl ketone, dipropyl ketone, methyl propyl ketone, methyl butyl ketone, and the like. Examples of the heterocyclic ketone compound include indene-1-one, 1,2,3-indanetrione, fluorene-9-one, 4-pyranone, and the like.

Examples of the aldehyde compound include: aliphatic aldehyde compounds comprising saturated aliphatic aldehydes such as formaldehyde, acetaldehyde, propionaldehyde, butyraldehyde, octaaldehyde, and nonaaldehyde, unsaturated aliphatic aldehydes such as acrolein, geranial, and citronellal, aliphatic polyaldehydes such as glyoxal, malonaldehyde, succinaldehyde, glutaraldehyde, adipaldehyde, pimelaldehyde, suberinaldehyde, and sebacinaldehyde; aromatic aldehyde compounds such as benzaldehyde, oxybenzaldehyde, cinnamaldehyde, salicylaldehyde, anisaldehyde, 1-naphthylaldehyde, phthalaldehyde, isophthalaldehyde, and telephthalaldehyde; and alicyclic aldehyde compounds such as formylcyclohexane.

In addition, examples of the ketone resin having a hydroxyl group include an urethane modified ketone resin having a hydroxyl group obtained by reacting: a ketone resin having a substituent group reactable with an isocyanate compound; with a polyisocyanate compound.

Examples of the polyisocyanate compound include aromatic diisocyanate compounds such as tolylenediisocyanate; alicyclic diisocyanate compounds such as 1,4-cyclohexane diisocyanate and isophorone diisocyanate; aliphatic diisocyanate compounds such as hexamethylene diisocyanate; araliphatic diisocyanate compounds such as α,α,α′,α′-tetramethylxylylene diisocyanate, and the like.

As the ketone resin having a hydroxyl group, a resin obtained by reacting an aromatic ketone compound with an aliphatic aldehyde compound and then hydrogenating the resulting ketone resin is preferable, and a resin obtained by reacting acetophenone with formaldehyde and then hydrogenating the resulting ketone resin is more preferable. Thereby, it is possible to preferably obtain the effects of the present invention.

Examples of commercial products of the ketone resin having a hydroxyl group include SK, PZZ-1201 (both are manufactured by Degussa), and the like. These ketone resins having a hydroxyl group may be used singly or as a mixture of two or more of them.

The content (usage) of the ketone resin having a hydroxyl group in the ink composition is preferably 8 to 20% by mass, and more preferably 10 to 18% by mass. In the case where the content of the ketone resin having a hydroxyl group is less than 8% by mass, a sufficient effect may not be obtained. In the case where it exceeds 20% by mass, a viscosity of the ink composition may increase, and the ink composition may be less likely to be ejected from a nozzle.

Next, a photopolymerization initiator contained in the ink composition of the present invention will be described in detail.

Specifically, as the photopolymerization initiator, a photopolymerization initiator of a molecule cleavage type or a hydrogen abstraction type is preferred. Examples thereof include benzoinisobutylether, 2,4-diethyloxanthone, benzyl, 2,4,6-trimethylbenzoyldiphenyl phosphine oxide, 2-benzyl-2-dimethylamino-1-(4-morpholinophenyl)-butane-1-one, bis(2,4,6-dimethoxybenzoyl)-2,4,4-trimethylpentyl phosphine oxide, 1,2-octanedione, 1-hydroxycyclohexyl phenyl ketone, benzoin ethyl ether, benzyl dimethyl ketal, 2-hydroxy-2-methyl-1-phenylpropane-1-one, 1-(4-isopropylphenyl)-2-hydroxy-2-methylpropane-1-one, benzophenone, 4-methylbenzophenone, trimethylbenzophenone, isophthalphenone, 4-benzoyl-4′-methyl-diphenylsulfide, 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-pipenyl-4,6-bis(trichloromethyl)-s-triazine, 2,4-bis(trichloromethyl)-6-styryl-s-triazine, 2-(naphtho-1-il)-4,6-bis(trichloromethyl)-s-triazine, 2-(4-methoxy-naphtho-1-il)-4,6-bis(trichloromethyl)-s-triazine, 2,4-trichloromethyl-(piperonyl)-6-triazine, 2,4-trichloromethyl(4′-methoxystyryl)-6-triazine, and the like. These may be used singly or as a mixture of two or more of them.

The usage of the photopolymerization initiator in the ink composition in the case of not using a sensitizer in combination, as described later, is preferably 5 to 20% by mass, and more preferably 5 to 13% by mass. In the case where the usage of the photopolymerization initiator is less than 5% by mass, curability to an active energy ray may not be sufficient. In the case where it exceeds 20% by mass, improvement of the effects may not be observed, leading to an excessive addition, this is not preferable.

In addition, in order to improve curability, it is also possible to use a sensitizer in combination with the photopolymerization initiator in the ink composition of the present invention. Examples thereof include trimethylamine, methyldimethanolamine, triethanolamine, p-diethylaminoacetophenone, ethyl p-dimethylamino benzoate, isoamyl p-dimethylamino benzoate, N,N-dimethylbenzylamine, 9,10-dibutoxyanthracene, 9,10-diethoxyanthracene, 9,10-dipropoxyanthracene, 9,10-bis(2-ethylhexyloxy)anthracene, 2,4-diethylthioxanthone, 2-isopropylthioxanthone, 4-isopropylthioxanthone, and the like.

The usage of the sensitizer in the ink composition is preferably 0 to 3% by mass, and more preferably 0.5 to 2% by mass. In the case where the usage of the sensitizer exceeds 3% by mass, improvement of the effects may not observed, leading to an excessive addition, this is not preferable.

In addition, the usage of the photopolymerization initiator in the ink composition in the case of using the sensitizer in combination is preferably 3.5 to 20% by mass, and more preferably 3.5 to 13% by mass.

A coloring agent may be contained in the ink composition of the present invention if necessary. As the coloring agent, coloring agents conventionally used in the ink composition can be used without any particular limitation. Among others, organic or inorganic pigments that disperse well to the ink composition and have excellent light resistance are preferable.

Examples of the organic pigment include dye lake pigment, azo pigment, benzimidazolone pigment, phthalocyanine pigment, quinacridone pigment, anthraquinone pigment, dioxazine pigment, indigo pigment, thioindigo pigment, perylene pigment, perynone pigment, diketopyrrolopyrrole pigment, isoindolinone pigment, nitro pigment, nitroso pigment, anthraquinone pigment, flavanthrone pigment, quinophthalone pigment, pyranthrone pigment, indathrone pigment, and the like. Examples of the inorganic pigment include carbon black, titanium oxide, red oxide, graphite, iron black, chromic oxide green, aluminum hydroxide, and the like.

The preferable usage of the pigment is 1 to 20% by mass in the ink composition. In the case where the usage of the pigment is less than the range, the image quality of the printed substance to be obtained tends to decrease. Meanwhile, values exceeding the range tend to have an adverse effect on viscosity property of the ink composition.

When using a pigment in the ink composition of the present invention, it is preferable to use a pigment dispersant in order to increase dispersibility of the pigment and storage stability of the ink composition.

As the pigment dispersant, conventionally used pigment dispersants can be used without any particular limitation, and it is preferable to use a polymeric dispersant among them. Examples of the polymeric dispersant include a carbodiimide dispersant, a polyesteramine dispersant, an aliphatic amine dispersant, a modified polyacrylate dispersant, a modified polyurethane dispersant, a multi-chain polymeric nonionic dispersant, a polymeric ion active agent, and the like. These pigment dispersants may be used singly or as a mixture of two or more of them.

The usage of the pigment dispersant is usually 1 to 200 parts by mass, and preferably 1 to 60 parts by mass, with respect to 100 parts by mass of all the pigments to be used. In the case where the usage of the pigment dispersant is less than 1 part by mass, dispersibility of the pigment and storage stability of the ink composition may decrease. Meanwhile, the usage of the pigment dispersant exceeding 200 parts by mass can be contained but may have no difference of effects.

A solvent may be contained in the ink composition of the present invention if necessary. As the solvent, it is possible to preferably use a solvent with a boiling point of 150 to 220° C. at normal pressure (1.013×10² kPa). Specific examples thereof include an ester organic solvent, an ether organic solvent, an ether ester organic solvent, a ketone organic solvent, an aromatic hydrocarbon solvent, a nitrogen-containing organic solvent, and the like. However, from the viewpoints of the curability of the ink composition and environmental problems, it is preferable to avoid using an organic solvent. Specifically, the content of the organic solvent in the ink composition is preferably 5% by mass or less, more preferably 2% by mass or less, and particularly preferably 0% by mass.

Various kinds of additives can be blended in the ink composition of the present invention in order to give various functionalities if necessary.

Specific examples thereof include a light stabilizer, a finishing agent, a surfactant, a viscosity lowering agent, an antioxidant, an aging preventing agent, a crosslinking promoter, a polymerization inhibitor, a plasticizer, an antiseptic, a pH adjuster, a defoaming agent, a moisturizing agent, and the like.

With respect to the ink composition of the present invention obtained from the above-mentioned constituent material, the viscosity at 25° C. thereof is preferably 5 to 50 mPa·s. Thereby, a preferable ink ejection performance and a thick printing film can be obtained.

In the present specification, the viscosity at 25° C. is measured using a B-type viscometer (trade name: RE100L viscometer, manufactured by TOKI SANGYO CO., LTD.).

A method for preparing the ink composition of the present invention is not particularly limited, and it is possible to prepare the ink composition by adding all of the above-mentioned materials and mixing them with a bead mill, a three-roll mill, or the like. Moreover, upon use of a pigment, a concentrated base ink is beforehand obtained by mixing the pigment, a pigment dispersant, and a photopolymerizable compound, and then components such as a ketone resin having a hydroxyl group, a photopolymerizable compound, a photopolymerization initiator, and a sensitizer are added to the concentrated base ink; whereby it is possible to prepare the ink composition.

Next, the printed substances obtained from the ink composition will be described.

As a substrate for printing the ink composition of the present invention, substrates made of polyethylene, polyester, polypropylene, styrene, or the like are preferable. And it is possible to print, without any problems, on the substrate on which the ink composition for ultraviolet ray ink-jet printing has been conventionally printed (paper, capsule, gel, metal foil, glass, wood, cloth, etc.).

Next, as a specific method for printing and curing the ink composition, the ink composition is ejected on the substrate, and thereafter the ink composition deposited on the substrate is exposed to light and cured.

For example, it is possible to perform ejection to a substrate (printing of images) by supplying the ink composition to a printer head of a printer apparatus for an ink-jet recording system, and ejecting the ink composition so as to give a film thickness of 1 to 20 μm on the recording material from this printer head. It is possible to perform exposure to light and curing (curing of images) by delivering light to the ink composition that is applied on the recording material as images.

As the printer apparatus for an ink-jet recording system for printing the ink composition, conventionally used printer apparatuses for ink-jet recording systems can be employed. Moreover, in the case of using a continuous type printer apparatus for an ink-jet recording system, a conductive agent is further added to the ink composition, and then electrical conductivity is adjusted.

Examples of the light source for curing of images include ultraviolet rays, electron rays, visible rays, light emitting diodes (LED), and the like.

The photocurable ink composition for ink-jet printing of the present invention has the above-mentioned constitution, excellent photocurability, excellent adhesiveness to a substrate, and excellent elongation property and flexibility.

### BEST MODE FOR CARRYING OUT THE INVENTION

Hereinafter, the present invention will be described in further detail by way of Examples, and the present invention is not limited to these Examples. Here, unless otherwise noted, “%” means “% by mass”, and “parts” means “parts by mass”.

The materials used in the following Examples and Comparative Examples are as follows.

### <Ketone Resin Having a Hydroxyl Group>

SK; a ketone resin having a hydroxyl group (manufactured by Degussa, a resin obtained by reacting acetophenone with formaldehyde and then hydrogenating the resulting ketone resin, hydroxyl value: 325 mgKOH/g)

### <Pigment Dispersant>

Ajisper PB821 (manufactured by Ajinomoto Co., Inc.)

### <Photopolymerizable Compound>

IBOA; Isobornyl acrylate
SR339; 2-phenoxyethyl acrylate (manufactured by SARTOMER Company, Inc.)
CD420; 2,3,5-trimethylcyclohexane acrylate (manufactured by SARTOMER Company, Inc.)
(PO) NPGDA; Propoxylated neopentyl glycol diacrylate
VCAP; N-vinyl caprolactam

### CN371;

(REACTIVE AMINE COINITIATOR, manufactured by SARTOMER Company, Inc., amine value: 137 mgKOH/g, containing two amino groups and two acryloyl groups)
HDODA; 1,6-hexanediol diacrylate
SR256; 2(2-ethoxyethoxy)ethyl acrylate (manufactured by SARTOMER Company, Inc.)
CN991; Bifunctional urethane acrylate (manufactured by SARTOMER Company, Inc.)

### <Mixture of Photopolymerization Initiator and Sensitizer>

### TPO/ITX/Ir184/TZT=55/15/20/10

TPO; 2,4,6-trimethylbenzoyl diphenyl phosphine oxide (manufactured by LAMBERTI Spa)
ITX; Isopropylthioxanthone sinsitiser (manufactured by LAMBSON Ltd.)
Ir184; Alpha-hydroxycyclohexyl-phenyl ketone (manufactured by CIBA)
TZT; Trimethyl benzophenone+Methyl benzophenone (manufactured by LAMBERTI Spa)

### <Additive>

BYK-377 (silicone additive, manufactured by BYK-Chemie GmbH)

### EXAMPLES 1 TO 8 AND COMPARATIVE EXAMPLES 1 TO 6

### Preparation of Photocurable Ink Composition for Ink-Jet Printing

A pigment (Pigment Blue 15:4), a pigment dispersant (Ajisper PB821, manufactured by Ajinomoto Co., Inc.), and a photopolymerizable compound (propoxylated neopentyl glycol diacrylate) were blended to obtain a mixture so that a blending ratio (mass ratio) thereof might be set to 25/10/65. The mixture was dispersed using Eiger Mill (using zirconia beads having a diameter of 0.5 mm as media) to obtain a concentrated base ink. Using the obtained concentrated base ink, the constituent materials were blended so as to give the formulation (% by mass) of Table 1 and 2, and the ink compositions of Examples 1 to 8 and Comparative Examples 1 to 6 were obtained.

The viscosities of the obtained ink compositions were 8 to 16 mPa·s (25° C.)

### <Printing of Ink Composition>

An ink-jet recording apparatus comprising a piezo type ink jet nozzle was filled in with the ink composition of each of the Examples 1 to 8 and each of the Comparative Examples 1 to 6. Subsequently, the ink composition was printed continuously on a polyethylene sheet (trade name; ECOS, manufactured by Interwrap Inc.) and a polyester sheet (trade name; TOYOBO ESTER FILM E5101, manufactured by TOYOBO CO., LTD, having a thickness of 100 μm) to obtain each of the images. The image having a predetermined thickness (10 μm) and favorable ejecting property of each of the ink compositions was obtained.

### [Performance Evaluation of Ink Composition]

The ink composition obtained in each of the Examples 1 to 8 and each of the Comparative Examples 1 to 6 was applied by a bar coater 44 on the polyethylene sheet (ECOS, manufactured by Interwrap Inc.), the polyester sheet (E5101, manufactured by TOYOBO CO., LTD), and a polyvinyl chloride sheet (Flontlit Grossy 120 g, manufactured by Cooley Inc.). Subsequently, the ink composition was cured using a D-bulb manufactured by FUSION UV SYSTEMS, INC. A cure rate (curability), adhesiveness, extensibility, crease resistance, and surface tackiness were evaluated by the following methods. Table 3 shows the results.

### (Cure Rate)

Using the D-bulb (mercury lamp) manufactured by FUSION UV SYSTEMS, INC., the cure rate was evaluated by the number of passes until the ink composition cured under irradiation conditions of 60 W×220 feet (67 m)/min, and a distance of 4 inches (10 cm) (UV cumulative amount of light: 148 mJ/cm²) (substrate; polyethylene sheet). The degree of curing was determined by rubbing the ink composition with a cotton swab and observing whether or not the ink composition was removed.

### (Adhesiveness)

Each of the cured films (substrate: a polyethylene sheet and a polyester sheet) was cut crosswise, and the degree of peeling of the ink was determined using a cellophane tape (100 pcs).

+++; No film was removed.
++; 1 to 30 films were removed.
+; 31 to 80 films were removed.
−; 81 or more films were removed.

### (Extensibility)

Each of the cured films (substrate: a polyvinyl chloride sheet) was put into an oven at 95° C. for 1 minute, both sides thereof were pulled after the film was taken out, and the extensibility was evaluated based on the degree of extending of the film.

+++; No film was cracked.
++; A portion of the film was cracked.
−; The entire film was cracked.

### (Crease Resistance)

Each of the cured films (substrate: a polyethylene sheet) was creased with both hands ten times, the crease resistance was evaluated based on the degree of peeling of the film.

+++; No film was peeled.
++; A portion of the film was peeled.
−; The entire film was peeled.

### (Surface Tackiness)

Each of the cured films (substrate: a polyethylene sheet) was touched with fingers, and presence of tack was evaluated.

+++; No tack was present on the surface.
+; A slight amount of tack was present on the surface.
−; Tack was present on the entire surface.

TABLE 1

| | Example | | | | | | | |
|---|---|---|---|---|---|---|---|---|
| | 1 | 2 | 3 | 4 | 5 | 6 | 7 | 8 |
| Concentrated base ink | 8.0 | 8.0 | 8.0 | 8.0 | 8.0 | 8.0 | 8.0 | 8.0 |
| Varnish of SK dissolved in SR339 (containing 40% by mass of SK) | 30.5 | 30.5 | 30.5 | 28.0 | 30.5 | 30.5 | NA | 30.5 |
| (% by mass of SK resin, ketone resin having hydroxyl group) | (12.2) | (12.2) | (12.2) | (11.2) | (12.2) | (12.2) | NA | (12.2) |
| (% by mass of SR339, 2-phenoxyethyl acrylate) | (18.3) | (18.3) | (18.3) | (16.8) | (18.3) | (18.3) | NA | (18.3) |
| Varnish of SK dissolved in IBOA (containing 20% by mass of SK) | NA | NA | NA | NA | NA | NA | NA | NA |
| (% by mass of SK resin, ketone resin having hydroxyl group) | NA | NA | NA | NA | NA | NA | NA | NA |
| (% by mass of IBOA, isobornyl acrylate) | NA | NA | NA | NA | NA | NA | NA | NA |
| Varnish of SK dissolved in CD420 (containing 20% by mass of SK) | NA | NA | NA | NA | NA | NA | 83.6 | NA |
| (% by mass of SK resin, ketone resin having hydroxyl group) | NA | NA | NA | NA | NA | NA | (16.7) | NA |
| (% by mass of CD420, 2,3,5-trimethylcyclohexane acrylate) | NA | NA | NA | NA | NA | NA | (66.9) | NA |
| SR339 (2-phenoxyethyl acrylate) | 15.6 | 15.6 | 15.6 | 15.6 | 26.5 | 5.8 | NA | 2.3 |
| IBOA (isobornyl acrylate) | 35.0 | 30.0 | 30.0 | 35.0 | 24.1 | 44.8 | NA | 20.3 |
| CD420 (2,3,5-trimethylcyclohexane acrylate) | NA | NA | NA | NA | NA | NA | NA | 28.0 |
| Varnish of SK dissolved in SR256 (containing 40% by mass of SK) | NA | NA | NA | NA | NA | NA | NA | NA |
| (% by mass of SK resin, ketone resin having hydroxyl group) | NA | NA | NA | NA | NA | NA | NA | NA |
| (% by mass of SR256, 2(2-ethoxyethoxy)ethyl acrylate | NA | NA | NA | NA | NA | NA | NA | NA |
| SR256 (2(2-ethoxyethoxy)ethyl acrylate) | NA | 5.5 | NA | 3.0 | NA | NA | NA | NA |
| CN371 (acrylated amine synergist, two amino groups, two acryloyl | 2.5 | 2.0 | 2.0 | 2.0 | 2.5 | 2.5 | NA | 2.5 |
| groups) | | | | | | | | |
| VCAP (N-vinyl caprolactam) | NA | NA | 5.5 | NA | NA | NA | NA | NA |
| HDODA (1,6-hexanediol diacrylate) | NA | NA | NA | NA | NA | NA | NA | NA |
| CN991 (bifunctional urethane acrylate, two acryloyl groups) | NA | NA | NA | NA | NA | NA | NA | NA |
| Mixture of photopolymerization initiator and sensitizer | 8.0 | 8.0 | 8.0 | 8.0 | 8.0 | 8.0 | 8.0 | 8.0 |
| BYK377 (silicone additive) | 0.4 | 0.4 | 0.4 | 0.4 | 0.4 | 0.4 | 0.4 | 0.4 |
| Sum (% by mass) | 100.0 | 100.0 | 100.0 | 100.0 | 100.0 | 100.0 | 100.0 | 100.0 |
| Amount of SK resin (% by mass, ketone resin having hydroxyl group) | 12.2 | 12.2 | 12.2 | 11.2 | 12.2 | 12.2 | 16.7 | 12.2 |
| 2-phenoxyethyl acrylate/isobornyl acrylate (mass ratio) | 49/51 | 53/47 | 53/47 | 48/52 | 65/35 | 35/65 | NA | 50/50 |
| Sum of content of acrylate having two or more functional groups | 7.7 | 7.2 | 7.2 | 7.2 | 7.7 | 7.7 | 5.2 | 7.7 |
| (% by mass) | | | | | | | | |
| Sum of percentage content of 2-phenoxyethyl acrylate, isobornyl acrylate | 90% | 83% | 83% | 87% | 90% | 90% | 93% | 90% |
| and 2,3,5-trimethylcyclohexane acrylate in photopolymerizable | | | | | | | | |
| compounds | | | | | | | | |

NA: Not Available

TABLE 2

| | Comparative Example | | | | | |
|---|---|---|---|---|---|---|
| | 1 | 2 | 3 | 4 | 5 | 6 |
| Concentrated base ink | 8.0 | 8.0 | 8.0 | 8.0 | 8.0 | 8.0 |
| Varnish of SK dissolved in SR339 (containing 40% by mass of SK) | NA | 16.8 | 41.8 | NA | NA | NA |
| (% by mass of SK resin, ketone resin having hydroxyl group) | NA | (6.7) | (16.7) | NA | NA | NA |
| (% by mass of SR339, 2-phenoxyethyl acrylate) | NA | (10.1) | (25.1) | NA | NA | NA |
| Varnish of SK dissolved in IBOA (containing 20% by mass of SK) | NA | NA | NA | 83.6 | NA | NA |
| (% by mass of SK resin, ketone resin having hydroxyl group) | NA | NA | NA | (16.7) | NA | NA |
| (% by mass of IBOA, isobornyl acrylate) | NA | NA | NA | (66.9) | NA | NA |
| Varnish of SK dissolved in CD420 (containing 20% by mass of SK) | NA | NA | NA | NA | NA | NA |
| (% by mass of SK resin, ketone resin having hydroxyl group) | NA | NA | NA | NA | NA | NA |
| (% by mass of CD420, 2,3,5-trimethylcyclohexane acrylate) | NA | NA | NA | NA | NA | NA |
| SR339 (2-phenoxyethyl acrylate) | NA | 28.3 | 41.8 | NA | NA | NA |
| IBOA (isobornyl acrylate) | 30.0 | 38.5 | NA | NA | NA | NA |
| CD420 (2,3,5-trimethylcyclohexane acrylate) | NA | NA | NA | NA | NA | NA |
| Varnish of SK dissolved in SR256 (containing 40% by mass of SK) | 30.0 | NA | NA | NA | NA | 41.8 |
| (% by mass of SK resin, ketone resin having hydroxyl group) | (12.0) | NA | NA | NA | NA | (16.7) |
| (% by mass of SR256, 2(2-ethoxyethoxy)ethyl acrylate | (18.0) | NA | NA | NA | NA | (25.1) |
| SR256 (2(2-ethoxyethoxy)ethyl acrylate) | 21.6 | NA | NA | NA | 83.6 | 41.8 |
| CN371 (acrylated amine synergist, two amino groups, two acryloyl groups) | 2.0 | NA | NA | NA | NA | NA |
| VCAP (N-vinyl caprolactam) | NA | NA | NA | NA | NA | NA |
| HDODA (1,6-hexanediol diacrylate) | NA | NA | NA | NA | NA | NA |
| CN991 (bifunctional urethane acrylate, two acryloyl groups) | NA | NA | NA | NA | NA | NA |
| Mixture of photopolymerization initiator and sensitizer | 8.0 | 8.0 | 8.0 | 8.0 | 8.0 | 8.0 |
| BYK377 (silicone additive) | 0.4 | 0.4 | 0.4 | 0.4 | 0.4 | 0.4 |
| Sum (% by mass) | 100.0 | 100.0 | 100.0 | 100.0 | 100.0 | 100.0 |
| Amount of SK resin (% by mass, ketone resin having hydroxyl group) | 12.0 | 6.7 | 16.7 | 16.7 | 0.0 | 16.7 |
| 2-phenoxyethyl acrylate/isobornyl acrylate (mass ratio) | 0/100 | 50/50 | 100/0 | 0/100 | NA | NA |
| Sum of content of acrylate having two or more functional groups (% by mass) | 7.2 | 5.2 | 5.2 | 5.2 | 5.2 | 5.2 |
| Sum of percentage content of 2-phenoxyethyl acrylate, isobornyl acrylate and | 43% | 90% | 93% | 93% | 94% | 0% |
| 2,3,5-trimethylcyclohexane acrylate in photopolymerizable compounds | | | | | | |

NA: Not Available

TABLE 3

| | Example | | | | | | | | Comparative Example | | | | | |
|---|---|---|---|---|---|---|---|---|---|---|---|---|---|---|
| <Evaluation> | 1 | 2 | 3 | 4 | 5 | 6 | 7 | 8 | 1 | 2 | 3 | 4 | 5 | 6 |
| Curability (polyethylene sheet, | 2 | 2 | 2 | 2 | 2 | 2 | 2 | 2 | 2 | 3 | 3 | 2 | 5 | 10< |
| number of passes) | | | | | | | | | | | | | | |
| Adhesiveness (polyethylene sheet) | +++ | ++ | +++ | ++ | ++ | +++ | +++ | +++ | ++ | + | − | +++ | + | ++ |
| Adhesiveness (polyester sheet) | +++ | +++ | +++ | +++ | ++ | +++ | +++ | +++ | +++ | + | +++ | +++ | +++ | +++ |
| Elongation (polyvinyl chloride sheet) | +++ | +++ | +++ | +++ | +++ | ++ | +++ | +++ | +++ | +++ | +++ | − | +++ | +++ |
| Crease resistance (polyethylene sheet) | +++ | +++ | +++ | +++ | +++ | ++ | ++ | +++ | +++ | ++ | +++ | − | ++ | ++ |
| Surface tackiness | +++ | +++ | +++ | +++ | +++ | +++ | +++ | +++ | − | +++ | +++ | +++ | + | + |
| (polyethylene sheet) | | | | | | | | | | | | | | |

The ink compositions obtained in the Examples were excellent in curability, adhesiveness, extensibility, crease resistance, and surface tackiness. In contrast, in the Comparative Examples, ink compositions excellent in all of these properties were not obtained.

### INDUSTRIAL APPLICABILITY

The photocurable ink composition for ink-jet printing of the present invention is applicable to a variety of substrates using an ink-jet recording system.

1. A photocurable ink composition for ink-jet printing containing:
a ketone resin having a hydroxyl group;
as a photopolymerizable compound,
(a) aromatic ring-containing acrylate, which is represented by the following formula (I), and isobornyl acrylate and/or (b) trimethylcyclohexane acrylate, 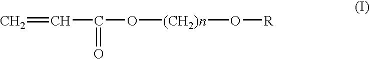
(in the formula, “R” represents an aromatic ring in which a hydrogen atom may be substituted by an alkyl group, and “n” represents an integer from 0 to 5);
and a photopolymerization initiator,
a blending ratio of said aromatic ring-containing acrylate to said isobornyl acrylate being 70/30 to 30/70 by mass, and
a content of said ketone resin having a hydroxyl group being 8 to 20% by mass.

2. The photocurable ink composition for ink-jet printing according to claim 1,
wherein said aromatic ring-containing acrylate is phenoxyethyl acrylate.

3. The photocurable ink composition for ink-jet printing according to claim 1,
wherein 1 to 10% by mass of acrylated amine compound having two photopolymerizable functional groups and two amino groups in the molecule is further contained as said photopolymerizable compound in said photocurable ink composition for ink-jet printing.

4. The photocurable ink composition for ink-jet printing according to claim 1,
wherein 1 to 10% by mass of N-vinyl caprolactam is further contained as said photopolymerizable compound in said photocurable ink composition for ink-jet printing.

5. The photocurable ink composition for ink-jet printing according to claim 1,
wherein a total content of polyfunctional monomers contained in said photocurable ink composition for ink-jet printing is 1 to 10% by mass.

6. The photocurable ink composition for ink-jet printing according to claim 1, wherein a viscosity at 25° C. is 5 to 50 mPa·s.

7. The photocurable ink composition for ink-jet printing according to claim 1, further containing a pigment.
